(19) United States
(12) Patent Application Publication
(10) Pub. No.: US 2015/0106119 A1
(43) Pub. Date: Apr. 16, 2015

(54) AUTOMATED WORKFLOW QUEUING SYSTEM AND METHOD FOR HEALTH CARE

(71) Applicant: Visual Clinic LLC, Westford, MA (US)

(72) Inventor: Dennis McCafferty, York, ME (US)

(21) Appl. No.: 14/456,305

(22) Filed: Aug. 11, 2014

Related U.S. Application Data
(63) Continuation of application No. 13/305,952, filed on Nov. 29, 2011, now abandoned.
(60) Provisional application No. 61/417,563, filed on Nov. 29, 2010.

(51) Int. Cl. G06F 19/00; G06Q 10/06

(52) U.S. Cl. CPC G06F 19/327; G06F 19/322; G06Q 10/06316
USPC 705/3

(57) ABSTRACT

An intelligent routing and automated workflow queuing system for a health care receives information related to health care provider patient treatment assets and individual patient data record information consisting of one or more patient information including urgent medical needs, special accommodation needs, VIP status, participation in a research or clinical trial, appointment reason, anticipated amount of health care provider work time needed for this visit, scheduled appointment start time, cumulative wait time in the health care provider setting for this visit as well as other variables. Responsive to this information, the system calculates a quantitative priority variable for each patient and then calculates a quantitative priority variable for each Health Care provider, for automatically prioritizing and queuing patients for a next care step based on the information related to the health care provider patient treatment assets and individual patient data record information.

### CROSS-REFERENCE TO RELATED APPLICATIONS

This application is a Continuation-in-Part of co-pending U.S. patent application Ser. No. 13/305,952 filed Nov. 29, 2011 and entitled “System And Method For Workflow Visualization And Communication Process Time Management” which in turn claims priority from U.S. Provisional Patent Application No. 61/61/417,563 entitled “System And Method For Workflow Visualization And Communication Process Time Management” filed on Nov. 29, 2010, both of which are incorporated fully herein by reference.

### TECHNICAL FIELD

The present invention relates to a system and method for tracking and managing resources utilized in providing patient treatment in a health care setting and more particularly, to an automated workflow queuing system and method for health care utilizing health care provider patient treatment asset information and individual patient data record information.

### BACKGROUND INFORMATION

All healthcare providers including, for example only, Ophthalmologists, are facing challenging market trends. Demand for medical services is growing rapidly due to population growth and aging while the number of practicing physicians is roughly static. New doctors graduating and entering the work force are expected to just compensate for those older doctors retiring and leaving the work force. One would expect rising demand for medical services which are limited in supply to result in higher prices. Reimbursement rates for medical services, however, are not rising, but rather they are falling. The growing demand for medical services is not only exceeding provider capacity but is exceeding the public and private funds available to pay for them. There are limitations on public and private resources available for funding medical services. Although patients have less money to pay and fewer doctors available to them, patients are becoming more demanding in terms of quick access, speedy appointments and pricing discounts.

These conditions dictate that physicians must see more patients, process them without delay, and expect less compensation for their services. The necessary increase in capacity and operating efficiency can only be achieved through increased leverage of the professional medical staff's time, resources and equipment.

Several industries were faced with similar challenges in the preceding decade. For example, the chemical industry, automotive manufacturing, and electronics manufacturing industries experienced extended periods of falling prices, rising costs and an unrelenting consumer demand for higher quality and shorter lead times. Despite these daunting challenges many firms have flourished. Their success is widely attributed to the adoption of Lean Manufacturing, the Toyota Production System (TPS), and Six Sigma techniques.

There are several key concepts at the center of these systems. First, a single piece flow that avoids batching. Second, a production rate set to match the Takt time (or cadence) of customer demand in order to avoid the waste of delays and the waste of overproduction. Third, a pace-setter operation that is identified and optimized for processing time, which is usually the scarcest resource. Fourth, all supporting process steps must be defined and work balanced to deliver a single piece at the same time interval as the pacesetter operation, often called work leveling. Fifth, a visual workplace, which is self-explaining, self-ordering and not reliant on verbal communication to initiate actions. Sixth, the system is process focused, meaning that all work is viewed as a collection of processes. Each process is defined and has quantifiable standards for inputs and outputs, each of these inputs and outputs is measured and process control feedback loops are employed to initiate corrective actions to keep the process under control and operating within control limits.

These same systems and methods offer opportunity and hope to healthcare providers. Some healthcare organizations have already begun to deploy them. The challenge is how to adapt these tools and methods from a manufacturing production process to a medical services process.

In a clinical services environment, the physician examination is the pace-setter step. This pace-setter time increment can be referred to as the takt time or process cadence. As a doctor can exam only one patient at a time, the upstream processes must advance the next patient (ready for examination) within the takt time. Failure to advance a patient leaves the doctor idle and creates waste (capacity loss). Advancing more than one patient leaves the patient idle and creates waste (patient wait time). To achieve consistent single patient flow, the pace-setter takt time must be known with statistical precision and all supporting processes must be organized into logical segments time-balanced to this time increment.

There are many existing problems with synchronous single patient flow used in medical offices. First, delays or work stoppages cascade through the system and are magnified due to interdependence and leverage. There are cumulative capacity losses. There is a cumulative effect on patient visit times. Slack time that is created through work balance and leveling represents added cost if the slack time is not utilized for other necessary “offline” clinical tasks.

Most manufacturing operations employ electronic industrial equipment. From this equipment process data concerning inputs and output, particularly process cycle times can be readily captured. This data can then be aggregated and analyzed against standards. Deviations can then be communicated through feedback loops for correction. In the medical services setting there is no such infrastructure or platform from which to capture process data. The majority of medical practices still employ manual paper systems. Electronic medical records (EMR) systems where deployed lack the capability to accurately and reliably provide process data.

In addition, in order to enhance operational performance and overall effectiveness a healthcare service organization must simultaneously optimize multiple competing objectives around a) Patient Volume—i.e. meeting patient demand, generating sufficient revenue; b) Efficiency—effectively using human resources and physical assets such as medical examination rooms, expensive diagnostic equipment, operating rooms, and other necessary devices; and c) Patient Experience—providing high quality care while minimizing waiting times.

Therefore, what is needed is a system that is capable of increasing capacity resulting in better leveraging of the Doctor's time, thereby creating higher revenue for the provider and practice and faster access to care for the patients. The system should reduce all waste, including both the waste of waiting and the waste of overproduction. The system should also improve patient satisfaction with visit times by eliminating long delays due to patient bunching and providing for predictable visit times. In addition, the system must be able to take advantage of both human and physical asset to enhance operational performance and overall effectiveness a healthcare service by simultaneously optimizing patient volume, efficiency and patient experience within the healthcare setting.

### SUMMARY

The present invention features an intelligent routing and automated workflow queuing system for controlling and organizing health care provider patient treatment in a health care provider office, said system comprising a plurality of health care provider patient treatment assets located in a health care provider office. The health care provider patient treatment assets include one or more medical staff, a plurality of medical examining rooms and a plurality of medical examination devices.

A central processing system is provided and configured for receiving information related to said health care provider patient treatment assets and individual patient data record information consisting of one or more patient information selected from the group of patient information consisting of urgent to medical needs, special accommodation needs, VIP status, participation in a research or clinical trial, appointment reason, anticipated amount of health care provider work time needed for this visit, scheduled appointment start time, cumulative wait time in the health care provider setting for this visit, and other variables, and responsive to information related to the health care provider patient treatment assets and individual patient data record information, for calculating a quantitative priority variable for each patient and for calculating a quantitative priority variable for each Health Care provider, for automatically prioritizing and queuing patients for a next care step based on said information related to said health care provider patient treatment assets and individual patient data record information.

The present invention also features, in another embodiment, a system for tracking and of managing patient treatment in a health care provider office, the health care provider office including a plurality of medical examining rooms and a plurality of medical examination devices. The system comprises a plurality of patient data record holding devices, each of the plurality of patient data record holding devices disposed at a predetermined physical location within the health care provider office. Each of the plurality of patient data record holding devices includes one or more individual patient data record holders, each of the one or more individual patient data record holders is configured for providing a patient data record holder signal indicating an individual patient data record has been placed in the individual patient data record holder. Each patient data record holder signal includes an indication of a time at which each individual patient data record was placed in a patient data record holding device and which of the plurality of patient data record holding devices the individual patient data record associated with the patient data record holder signal was transmitted from.

Also included in one embodiment of the system is one or more sensors disposed within each of the plurality of medical examination rooms and each of the plurality of medical examination devices. The one or more sensors are configured for providing a signal indicating at least whether each of the plurality of medical examination rooms and medical examination devices are in a first use state or in a second not in use state.

The system further includes at least one individual patient data record processing device. The at least one individual patient data record processing device is configured for (a) allowing a health-care worker to identify an individual patient utilizing patient identification indicia included on the individual patient data record; (b) allowing the health-care worker to identify the next process step required by the individual patient; (c) allowing the health-care worker to enter a health-care worker identification code; and (d) allowing the health-care worker to enter an indication of which of either a medical examination room or a medical examination device is to be used for each individual patient, and for providing an individual patient data record processing device signal containing the individual patient identification indicia and the health-care worker entered information.

The system further includes a central processing system, which is configured for receiving each of the patient data record holder signals and each of the individual patient data record processing device signals, and responsive to each of the received patient data record holder signals, recording the time at which each the individual patient data record was placed in the patient data record holding device and which of the plurality of patient data record holding devices the patient data record holder signal was transmitted from. The central processing system then generates a listing of each patient data record holding device, including one or more individual patient data records placed therein. The central processing system organizes the generated listing by the indication of time at which each individual patient data record was placed in each patient data record holding device, in order to organize the generated listing starting with the individual patient data record that was placed in a given data record holding device the earliest in time. The central processing system is responsive to each individual patient data record processing device signal, storing information contained in each individual patient data record processing device signal and providing, for display, an indication of each received individual patient data record processing device signal.

The present invention further includes a display device, which is electronically coupled to the central processing system. The display device is configured for displaying each generated listing of patient data record holding devices including one or more individual patient data records placed therein and each individual patient data record processing device signal.

The system may further include a plurality of sensors disposed within each of the plurality of medical examination that are configured for providing an indication of when the examination room is in a not in use state; when the examination room is in an occupied state; when the examination room is in a state identified as occupied by a patient ready for examination by a medical practitioner; and when the examination room is in a state identified as patient in the examination room is being tended to by a medical practitioner.

In another embodiment, at least one of the plurality of patient data record holding devices includes one or more individual patient data record holders associated with a programmable timer, and wherein the central processing means records and provides an indication of an amount of time remaining on the programmable timer, and further were in the central processing means does not include the individual patient data record in and organized generated list of individual patient data records until the programmable timer associated with the individual patient data record has expired.

In a further embodiment, the central processing system is responsive to at least the plurality of sensors disposed within each of the plurality of medical examination rooms and each of the plurality of medical examination devices, for computing one or more of the percentage of health-care worker utilization time; the percentage of medical examination room utilization time, and a cumulative individual patient wait time.

In yet another embodiment, the central processing system is responsive to the plurality of patient data record holding devices, the plurality of sensors disposed within each of the plurality of medical examination rooms and each of the plurality of medical examination devices, and the at least one individual patient data record processing device, for computing patient constraint analysis for providing an indication of constraint data indicating problem areas in the health-care office.

The present invention may also further include at least one health-care worker entry device, for providing an indication to the system of the availability of each health-care worker for assignment within the health-care provider office.

The central processing system may include a data base containing information including one or more of: one or more skills possessed by one or more health-care workers; accessibility by disabled individuals to one or more medical examination rooms; and one or more factors to be considered in providing the best, easiest and most timely medical care to each individual patient.

In an additional embodiment of the present invention, the central processing system provides information concerning any patient visit to workflow constraint caused by a physical facility constraint, a clinical resource constraint or a combination of both a clinical resource and facility constraint.

Although the present invention will be explained in the context of an ophthalmology practice, it is important to note that the present invention is not intended to be limited to a system or method which must satisfy one or more of any stated objects or features of the invention. The ideas and features disclosed in the invention can be implemented and practiced equally as well in other medical practices, albeit reconfigured or adapted for the particular practice needs. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is a block diagram of a system for tracking and managing patient treatment in a health care provider office, according to one embodiment of the present invention;

FIG. 2 is a detailed schematic view of a system for tracking and managing patient treatment in a health care provider office, according to one embodiment of the present invention;

FIGS. 3A and 3B are detailed views of the patient flow process according to one embodiment of the present invention;

FIG. 4 is a detailed grid view of a patient flow time according to one embodiment of the present invention;

FIG. 5 is a detailed view of the visual process flow communication according to one embodiment of the present invention;

FIG. 6 is a detailed view of a check-in station for patient charts, according to one embodiment of the present invention;

FIG. 7 is a detailed view of a chart docking station, according to one embodiment of the present invention;

FIG. 8 is a flow chart illustrating a process constraint logic analysis which may be carried out by the system of the present invention;

FIG. 9 is an exemplary report from the system of the present invention in the form of a graph reporting on the number of patient workups and average patient workup times for each of a number of clinicians;

FIG. 10 is an additional exemplary report from the system of the present invention in the form of a chart illustrating cumulative minutes that patients waited for workup by a clinician; and

FIG. 11 is yet another exemplary report from the system of the present invention in the form of a graph illustrating cumulative average patient workup times for all clinicians combined.

### DETAILED DESCRIPTION OF THE PREFERRED EMBODIMENTS

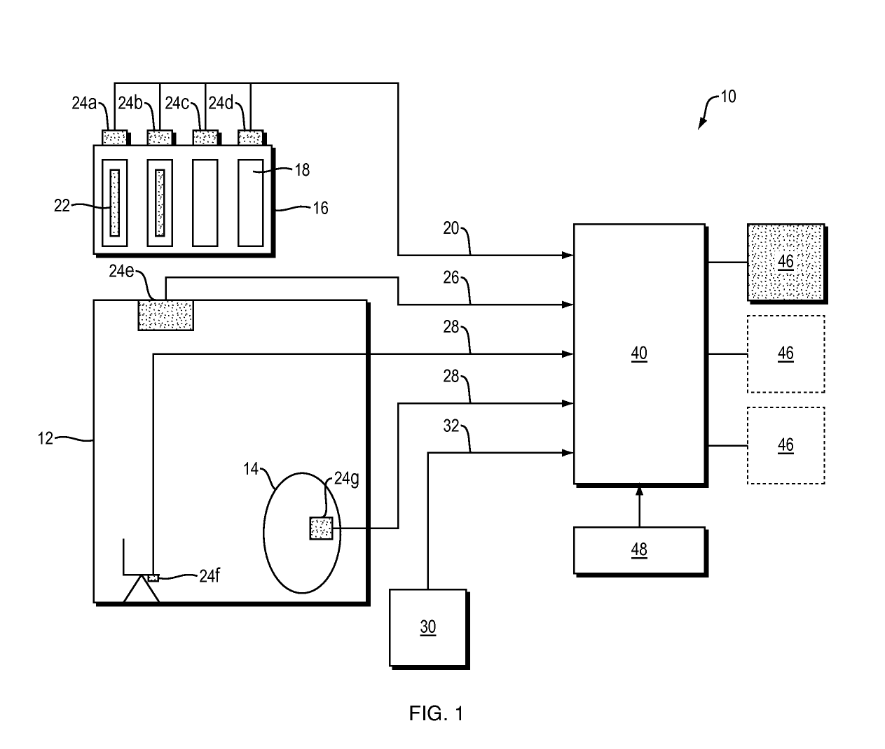

The present invention features a tracking and management system 10, FIG. 1, for patients in a health care setting. The tracking and management system includes a plurality of sensors 24. Each patient 42 has an individual patient data record 22 associated with the patient. The individual patient data record 22 is tracked throughout the visit through a plurality or series of patient data record holding devices 16 that feature one or more individual patient data record holders 18. Each patient data record holding device 16 includes one or more sensors 24 (for example, 24a, 24b, 24c, etc.). An exemplary data record holding device is a file folder equipped with one or more sensors 24. The sensors 24 detect the presence of an individual patient data record 22 in the individual patient data record holder 18 of the patient data record holding device 16, and then transmit a “patient data record present” signal 20 to a central processing system 40.

The tracking and management system 10 also uses additional sensors 24 to track and monitor people and items within the health care office. For example, a sensor 24f may be attached to a chair in an examination room. This sensor 24f is designed to detect the presence or absence of a person who is sitting in the chair. A sensor 24e can also be used in the room and this type of sensor may be a motion sensor, which is designed to detect the presence of movement in the medical office, either by a patient or by a health care provider. Another sensor 24g may be physically connected to a medical exam device 14. The medical exam device 14 can be any equipment or material used by a medical professional. The sensor 24g attached to the medical exam device 14 indicates the use or non-use of the medical exam device 14. All of the sensors 24 communicate with the central processing system 40.

The tracking and management system 10 further includes at least one individual patient data record processing device 30. The individual patient data record processing device 30 communicates with the central processing system 40 through the use of an individual patient data record processing device signal 32. The individual patient data record processing device 30 allows a health care worker to identify an individual patient using a patient identification mark or indicator (not shown) included on the individual patient data record 22. The individual patient data record processing device 30 allows the health care worker to identify the next process step required by each individual patient. The individual patient data record processing device 30 also allows the health care worker to enter a health care worker (user) identification code.

The health care identification code can be any identifier that specifically identifies one health care worker from another health care worker, such as password, employee ID, or other identifier. Additionally, the individual patient data record processing device 30 allows the health care worker to enter an indication of which medical exam room 12 and any medical exam devices 14 are to be used for any individual patient. All of the information entered about the individual patient and about the health care worker is transmitted to the central processing system 40 via the individual patient data record processing device signal 32. Examples (without limitation) of patient data record processing devices 30 includes a keyboard, touchpad, scanner, and the like.

In use, a health care worker 44 determines the next patient 42 in queue and ready for service as described herein and takes the individual patient data record 22 representing the next patient in the patient data record holding device 16 and moves the patient into a work step. The state of all hard assets such as medical exam rooms 12 and medical equipment or medical exam devices 14 is known. This is achieved by monitoring several sensors 24 located at each room and with various equipment. One such sensor 24e is a motion sensor designed to detect human presence in a medical exam room or other room. If no human presence is detected the room is considered to be state zero or “Not in Use”. This provides knowledge to the tracking and management system 10 and health care works 44 as to where to bring the next patient 42 for service.

Medical exam rooms may have additional states for communicating activity and process status. For example, the following states are possible: State 0—Exam room not in use; State 1—Exam room occupied; State 2—Exam room patient ready for doctor; State 3—Exam room doctor exam in progress. Medical exam room states will vary based on the office size and practice type. By monitoring the medical exam room states, important system productivity data can be measured, such as Doctor time utilization (% of total time in state 3), Room utilization (% of time not in state 0), Cumulative Patient wait time at this process step (% of time in state 2) as well as other system productivity data.

The central processing unit 40 also receives information from an input device 48. Examples of input devices include data entry keyboards, mouse, touchpad and the like. The input device 48 allows a health care worker, receptionist, or another employee (or perhaps the patient as well if the office practice depends on a patient self registering, for example) to enter any data or information necessary to create patient records, to make notes of patient preferences, or any other information. The central processing unit 40 that is comprised of appropriate processing hardware running appropriate computer software receives all of the signals (20, 26, 28) from the various sensors 24, and records the signals and their times.

For example, the central processing device 40 receives a signal 20 from the sensor 24a of the patient data record holding device 16 indicating that an individual patient data record 22 has been placed into an individual patient data record holder 18. The central processing unit 40 records the exact time that the individual patient data record 22 enters the individual patient data record holder 18 and subsequently will record the time that the individual patient data record 22 remains in the individual patient data record holder 18, this recording of time ending when the individual patient data record 22 is removed from the individual patient data record holder 18.

The central processing unit 40 is capable of generating a list of each patient data record holding device 16 that includes one or more individual patient data records 22 and then generating a listing that is compiled based on the entry time of each individual patient data record 22 into each patient data record holding device 16. The listing can be relative to each patient data record holding device 16 individually or can combine one or more patient data record holding devices 16 into a single list. The lists begin with the individual patient data record 22 that was placed in the patient data record holding device 16 earliest in time.

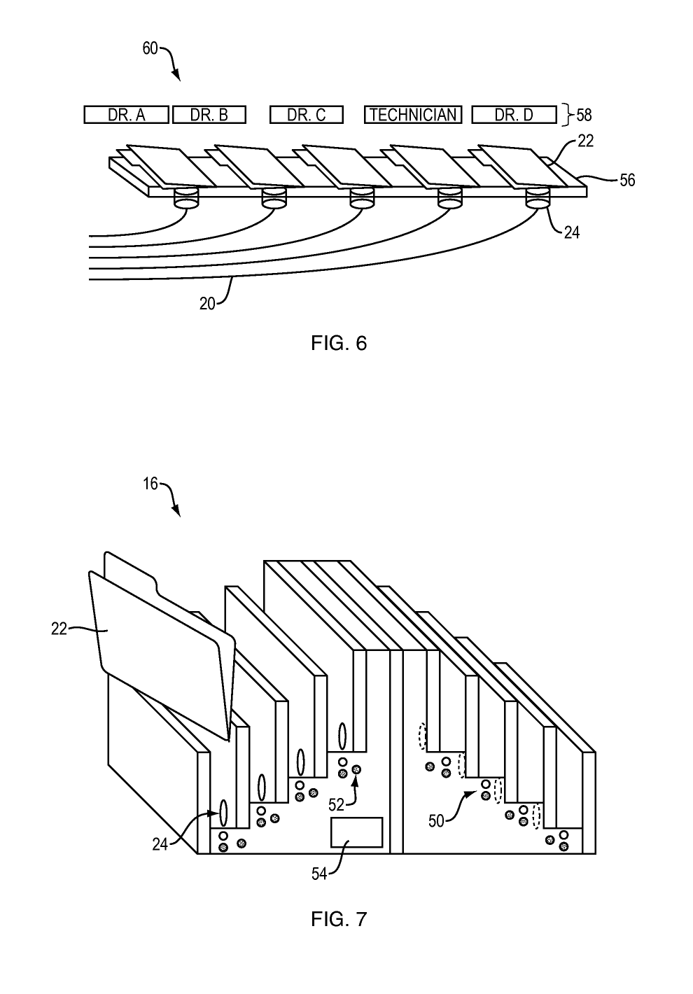

For example, at check-in 36, a patient data record holding device 16 may include one or more individual patient data records 22, FIG. 7. As each individual patient data record 22 is placed into an individual patient data record holder 18 of the patient data record holding device 16, a patient data record holder signal 20 is sent to the central processing unit 40. The central processing unit 40 organizes the individual patient data records 22 into a list using a first in, first out priority system, with the earliest being first on the list. The sensor 24, which may also be referred to as a proximity switch, senses the presence of the patient chart or record. The patient data record holding device 16 may also include a priority re-order button 52, which allows for a manual override of the first in, first out system. The priority re-order button 52 can be pressed, thereby moving the individual patient data record 22 to an earlier position in the list.

The patient data record holding device 16 may also feature a lighting system or one or more status indicator lights 50. The status indicator lights 50 are designed to indicate the patient status. For example, a green light would indicate that the patient is ready for the next step and that the patient is first on the list or queue. A red light would indicate that the patient is not ready for the next step in the process. The status indicator lights 50 may include other colors or various patterns, such as flashing, to signal any number of various status possibilities. The patient data record holding device 16 may also include a display screen 54. The display screen 54 may be an LCD display or another type of display. The display screen 54 may include graphics and/or text, which can display any information pertinent to the medical office and/or the health care workers, such as room use assignment, the doctor using the room today, and any other messaging.

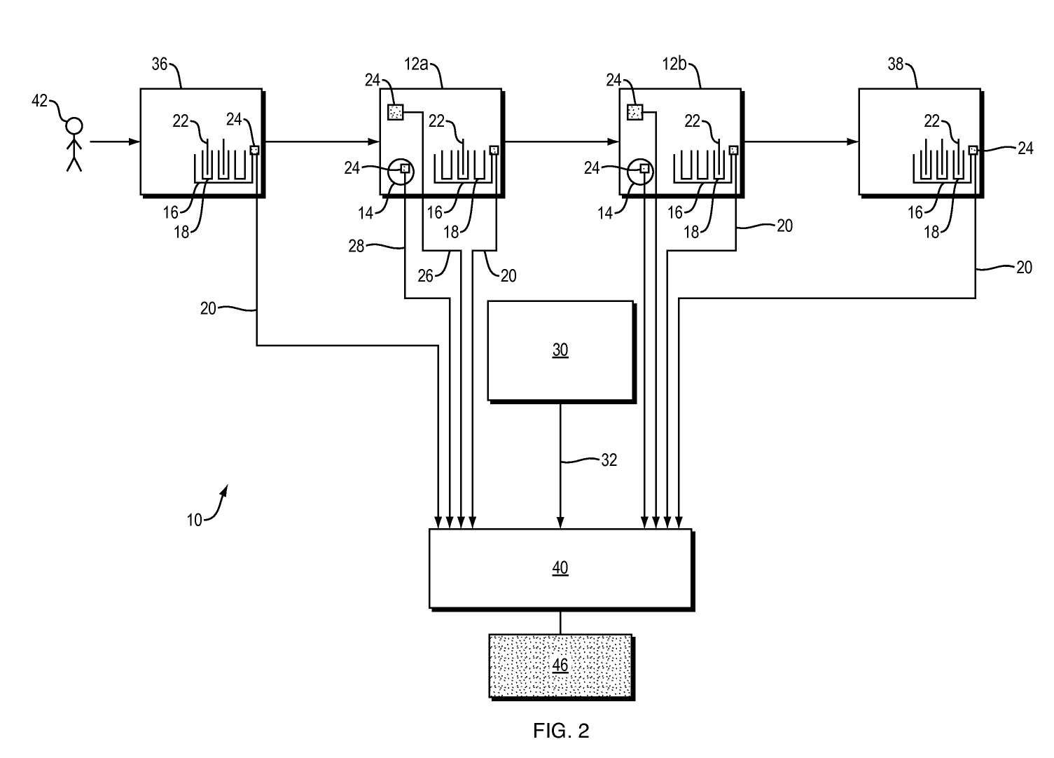

In one embodiment, the tracking and management system 10 is designed to be used in a medical office, FIG. 2. This tracking and management system 10 preferably includes multiple patient data record holding devices 16. For example, a first patient data record holding device 16 may be present at check-in, a second patient data record holding device 16 may be present outside a first medical exam room 12a, a third patient data record holding device 16 may be outside a second medical exam room 12b, and a fourth patient data record holding device 16 may be at check-out 38. Each patient data record holding device 16 may feature one or more individual patient data record holders or “positions” 18. For example, the waiting or check-in area 36 will preferably feature a patient data record holding device 16 that includes a plurality of individual patient data record holders 18, while each medical exam room 12 would feature a patient data record holding device 16 with a single individual patient data record holder 18.

The tracking and management system 10 of this embodiment features a plurality of sensors 12, located on patient data record holding devices 16, located within medical exam rooms 12, attached to medical exam devices 14 or to other objects, such as chairs. The sensors transmit information to the central processing unit 40. An incoming patient 42 can proceed to check-in 36 and through any various needed medical exam rooms (12a, 12b, etc.) and then to check-out 38.

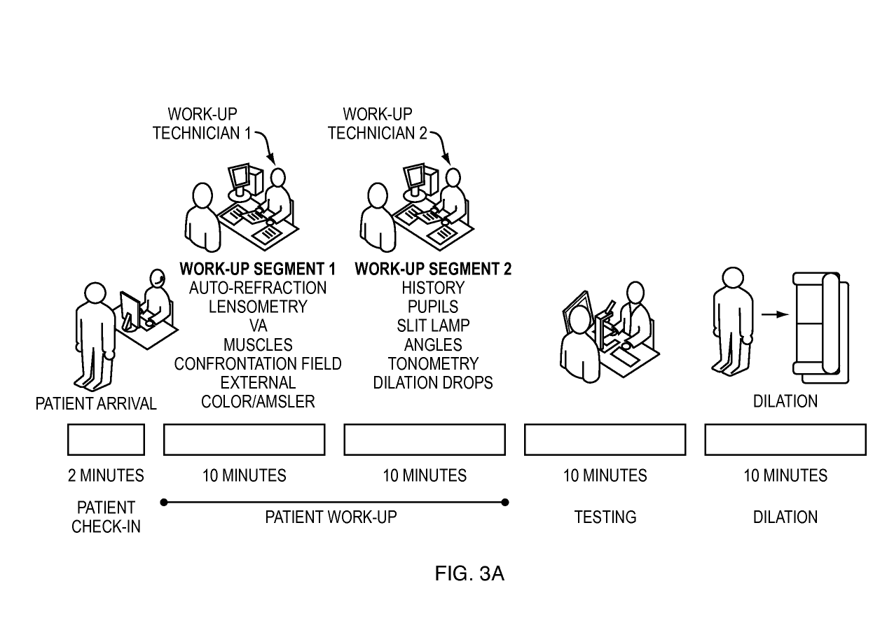

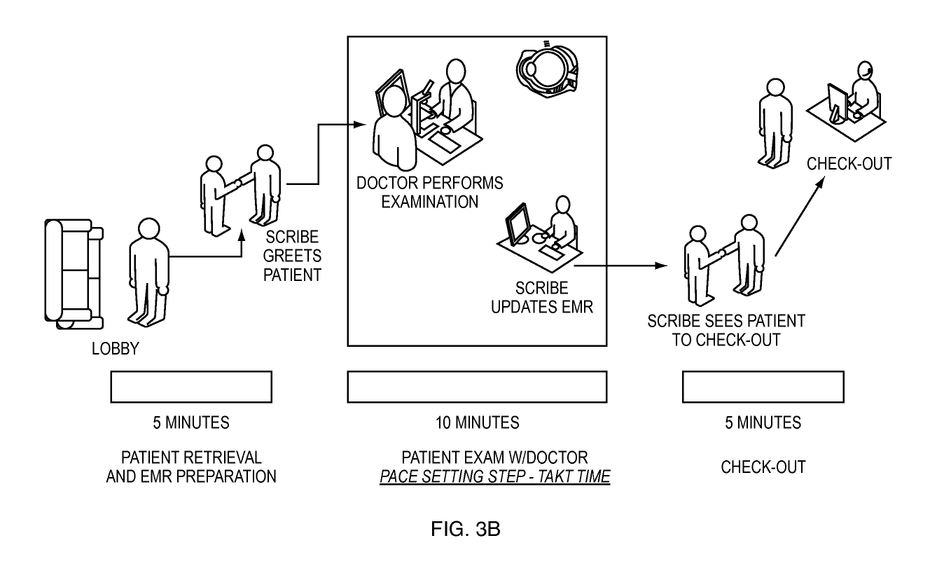

The patient flow process, FIGS. 3 and 4, details the process steps that are designed to advance one patient within the takt time or cadence time. In this embodiment, an example of a patient eye examination is used to show a detailed view of how the tracking and management system 10 can be used during a patient visit. A patient visit includes multiple process segments, including arrival, a work up with one more technicians, various testing, a timed dilation component that includes a waiting period, a doctor examination as well as a checkout process. The tracking and management system 10 is designed around creating an efficient and profitable office centered around the takt time, which is the pace setting step in the process.

Each process segment is organized and time balanced to the doctor examination takt time. A detailed view of the process segments, FIG. 4, illustrates the sequential steps and the interdependence of each provider on the overall execution and performance of the tracking and management system 10. The tracking and management system 10 is able to show workload balancing by process segment. For example, the tracking and management system 10 can show various parameters, including but not limited to value-added face time spent with a patient and worker slack time. Each parameter can be shown in the grid view using a different color or pattern.

The present invention is designed to create a workflow visualization and communication system, essentially a visual clinic. The central processing system 40 uses a series of one or more display devices 46. The display devices 46 display information output, such as the priority lists generated by the central processing system 40, to the health care workers in the office. The display devices are typically a computer type screen or monitor or can be a television screen, such as an LCD, plasma or projection screen. In a preferable embodiment of the present invention, a plurality of display devices 46 are located throughout the health care office, providing health care workers with easy access to view the information.

For example, as the system has knowledge of a) a patient waiting for a specific service; b) the availability of all workers capable of performing that service; and c) the availability of the medical exam room or medical exam device or equipment needed to provide the service, the tracking and management system 10 becomes capable of creating efficiency. For example, the tracking and management system 10 presents preferential queuing with two-way communications, thereby directing service tasks to the most advantageous worker currently available and to the equipment/room most effective for providing the service. When the individual patient data record 22 is placed in the patient data record holding device 16, the health care worker 44 that is placing the individual patient data record 22 may select any special requirements for this patient. For example, a bilingual healthcare worker or wheelchair access, or any other special requirements. The tracking and management system 10 would then notify first the most preferred health care worker that is bilingual. The tracking and management system 10 would also instruct the health care worker to choose a medical exam room that has the best accommodations for wheel chair service. If no special accommodations are necessary, the service would be directed to the overall most preferred worker. The preference could be based on best productivity or it could be based on a distribution scheme for ensuring all service providers see an equal amount of patients or any other distribution mechanism as determined by the health care office. When a health care worker is assigned an individual patient data record 22, the icon on the display device 46 will display that health care worker's initials or another identifying mark.

A health care worker that is notified of an individual patient data record 22 assignment through the notifier popup message system is able to confirm or “claim” the patient by clicking on the chart icon 62 on the display device 46. From the time the individual patient data record 22 has been assigned until the time it is “claimed” the chart icon 62 on the display device 46 is displayed with the assignee initials but in a state that designates that it has not been acknowledged and “claimed”. Once “claimed” the icon appearance will change to reflect that it is now confirmed and “claimed”. The tracking and management system 10 provides constraint data for determining the bottlenecks in the service process.

The process provides specific process data for use in commercial process improvement simulation. Commercial process improvement simulation software programs require process data in the format of a) frequency distribution of process cycle times by process step and b) the probability that the resources needed for the next process step will be available. For example, to create a simulation model for patient process times for work up the following data must be known a) work up cycle time in frequency distribution format, not simple averages; and b) probability that a worker and/or room will be available when a chart or card reaches the queue station for workup. The tracking and management system 10 is uniquely able to provide this data in a format that can be used directly for simulation studies for process improvement.

The information generated by the central processing system 40 and shown on the display devices 46 provides the tools to remove delays in processing patients and utilize system slack time for productive offline tasks. Visual communications are the key. Visual cues indicating patient status tell nurses and technicians when a patient is ready for the next step in the process. These are analogous to the Kanban cards used in Lean Manufacturing operations. Visual status on room and equipment availability tells them where to perform this work. Visual status of the entire clinic (patients, rooms and equipment) enhances the physician's decision making on whether to order same-day tests or when to step out for important tasks such consult phone calls, consultation letters, etc.

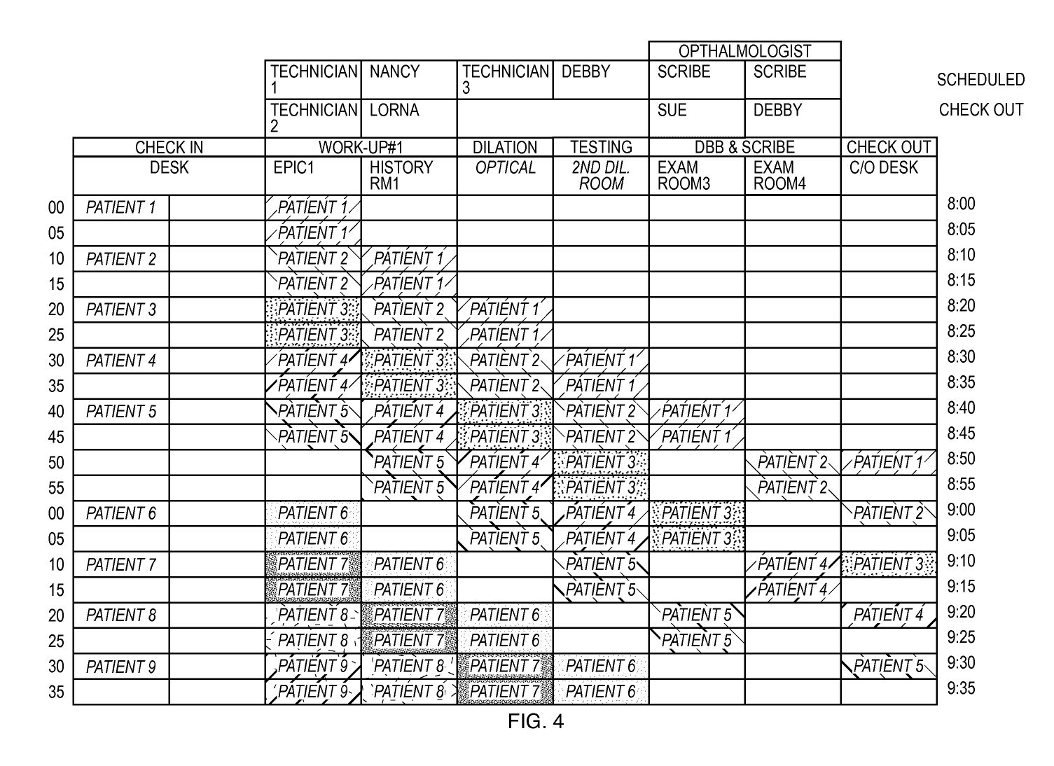

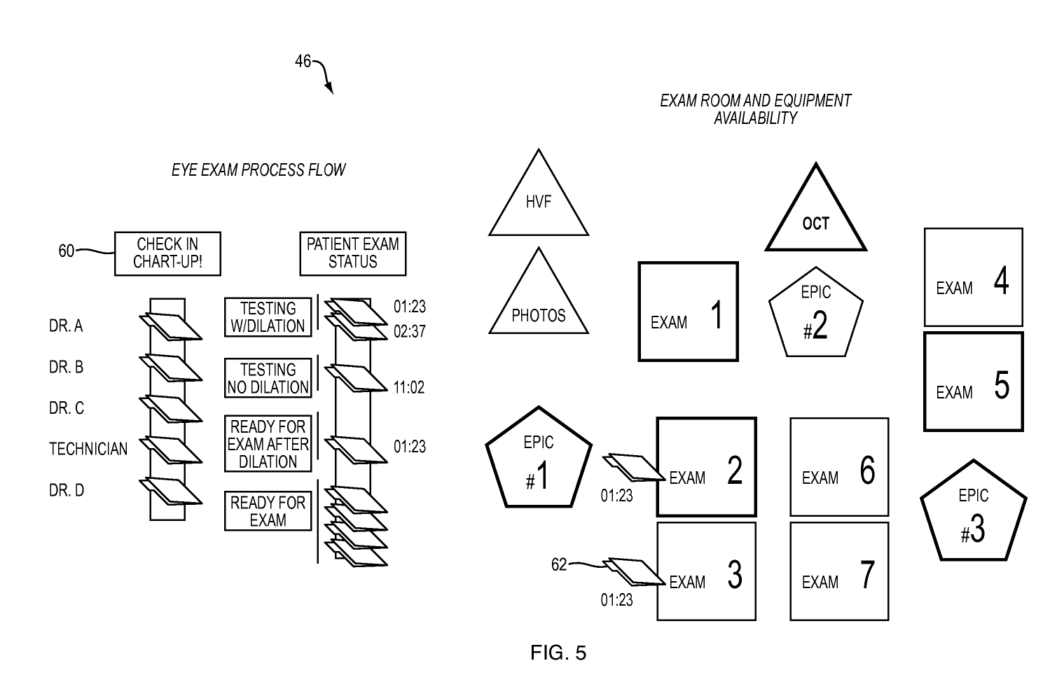

The check-in process of the tracking and management system 10, FIG. 5, includes a check-in and chart up station 60, FIG. 6, for each individual patient data record 22. In this embodiment, each individual patient data record 22 is placed onto a surface 56, such as a table or shelf. The surface 56 includes a plurality of sensors 24 located along a side of the surface 56. Each sensor 24 registers the presence of an individual patient data record that is located at the pick up station. The sensor 24 then transmits the reception of an individual patient data record 22 via a patient data record holder signal 20 to the central processing unit 40, including a time associated with the placement. The surface 56 may be labeled with one or more place holders or identifiers 58, which may include specifics about the health care worker who is designated to handle a particular patient data record 22, such as Dr. A, Dr. B, Technician 1, Technician 2, etc.

The check-in and chart up station 60 is designed to improve communication. The check-in and chart up station 60 sends signals to the central processing unit 40, which in turn notifies a doctor or technician that there is patient 42 who has checked in, completed their preregistration and is now is ready to begin their examination. This notification occurs by display of the information on the display devices 46. Software that runs on the central processing system 40 is designed to acknowledge the sensor status and light up a chart icon on the display device 46 as well as creating a pop up message for the health care worker at their designated computer workstation or at another computer based display, such as a smartphone or tablet.

The tracking and management system 10 accomplishes communication objectives by allowing health care workers to communicate at a glance 1) the next patient to be seen; and b) what the next process step is for that patient. For example, in an ophthalmology setting, the sensors 24 register the presence of an individual patient data record 22 in an individual patient data record holder 18 of the patient data record holding device 16. Each individual patient data record holder 18 has a programmable dilation delay timer. Individual patient data record holders 18 assigned to “No Dilation Required” have the timer set to zero seconds. Slots assigned to “Dilation Required” have the timer set to the average dilation time (15 minutes would be typical).

The software of the central processing device 40 monitors the sensor status of each sensor 24 and creates a visual clinic shown on the display device 46, FIG. 5. When an individual patient data record 22 is placed in a patient data record holding device 16 (see FIG. 7) a chart icon 62 appears on the display device 46 in that patient data record holding device 16 position. When that individual patient data record 22 reaches the top of the queue the slot status light turns green 50 on the docking station (16 or 60) and on the display device 46. A pop up message is then sent to the clinician at their designated computer workstation or to their computer base device communicating the need to take action.

The check-in chart docking station 60, when used in an ophthalmology setting, facilitates the efficient movement of a patient from one process step to the next where there is a) a planned time delay (dilation time for eye exam) or b) a different clinician assigned to the next process step. The check-in station 60 segregates patients requiring dilation delay from those that can advance immediately to next step. Charts placed in the section “No Dilation Required” enter immediately into the queue. The dilation section is configured with a programmable timer. When a chart is placed in “Dilation Required” section the indicator for that slot immediately turns red. After the timer set point is reached the red light is turned off and the patient is entered into the queue. The queue logic is first in-first out.

The patient chart next in queue is highlighted by a green inidicator light. While more than one patient may be ready for the next step, only the chart at the top of the queue is green. If a clinician determines that the patient priority should change they are able to overide the first in-first out logic and move any chart to the top of the queue by pressing the priority re-order button 52 provided for that individual patient data record holder 18. Chart docking stations are deployed, for example, at the following process points: pre-testing and exam ready.

In one embodiment, a Doctor alternates between two exam rooms. The presence of an individual patient data record 22 in the patient data record holding device 16 indicates to the Doctor or other health care worker that the patient is in the room and is ready to be seen. If there is a chart present at more than one room a colored indicator light 50 tells the doctor or health care worker which patient to see first. Indicator lights 50 work off of first in/first out logic. When an individual patient data record 22 is placed in the patient data record holding device 16 a sensor 24 registers its presence. The software of the central processing system 40 records the time of placement and begins an elapsed time counter. The central processing system 40 compares the time of each individual patient data record 22 within one or more single patient data record holding devices 16. The individual patient data record 22 that has the longest elapsed time (or that was the first to enter the patient data record holding device 16) is first. All other individual patient data records 22 are set in the order of entry.

The time based queue can be over-ridden. A Doctor, nurse or other health care worker 44 may move any patient 42 to the top of the queue by pressing the Priority Re-order button 52 for that medical exam room 12. Communications to the doctor that a patient is now ready are accomplished by: Status change on internal web browser. A chart icon 62 appears on a display screen 54 in front of the medical exam room 12 and the elapsed time counter is displayed in real time. A pop up message is sent to the doctor's designated office computer or other communication device. A text message, email or other notification is sent to doctor's smart phone or pager.

The present invention provides the means to collect, calculate, analyze and graphically view process time information. This process enables:

Design validation: Confirmation that work breakdown is in balance and supports process segment times at the designated takt time.

Analysis of variation: Provides statistical information about process variations as a function of 1) Appointment type; 2) individual performers (technician, scribe, and doctor).

Reaction to anomalies: Provides Andon notification when a patient visit time exceeds control limits.

Overall Visit Times Conformance Trending: Measures performance to office visit times standards.

### Analysis of Variance

### Dependent Variables: Process Segment Times

Overall Visit Times
% of Office Visits Conforming to STD Time

### Independent Variables: Appointment Reason

Patient Age
Patient Medical Condition Complexity
   Work up Technician assigned
Scribe Nurse assigned
Doctor
Time of day
Day of week

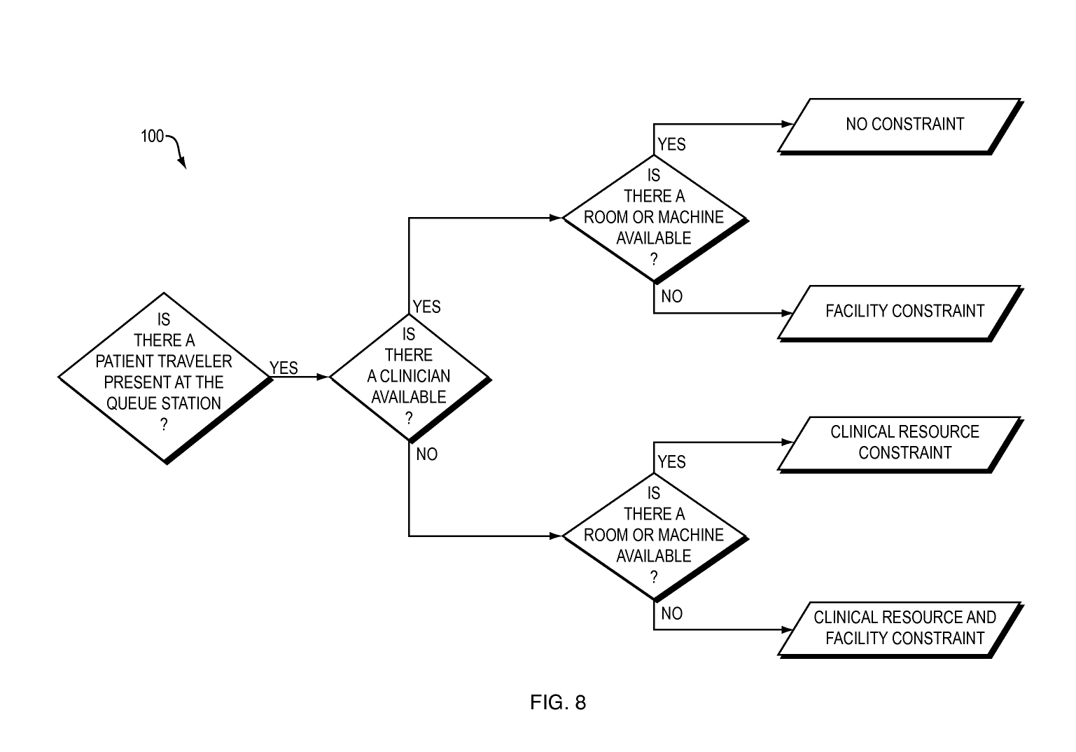

as shown for example in the logic chart 100 of FIG. 8, the present invention allows the central processing unit to gather statistical information and provide to the system administrator process constraint as shown, for example, in the process constraint logic chart 100. In this manner, the facility or system administrator is able to look back on statistical information to determine whether there is a facility constraint (additional examination rooms or exam equipment is required) or whether additional clinicians or other staff members are required.

The recorded process data is used to identify statistical relationships and causes of variation in the process. Six Sigma methods such as regression, one-way ANOVA, run charts, I-MR charts, U charts are used. The process details actual process time stamps and segment time durations, as well as process segment time averages based on appointment type and patient visit percent conformance process time standard, among other process time results. A process control system warning allows anomalies to be quickly addressed. As soon as the “actual” process time exceeds a predetermined “standard” process time control limit, a popup message or other notification or alert is sent to the computer based device (cell phone for example) of the health care worker or the staff member responsible for process monitoring and corrective actions. In this way, actual process times can be identified rapidly and real-time and addressed. Actual performance process times can be charted over days, weeks, months or any other timeline.

Other notable features of the present invention include playback capability, such that a snapshot of all asset and resource states are captured and logged in a database file at preprogrammed time intervals. A typical time interval would be 10 to 30 seconds apart. This historical data may then be played back through the device display at a preselected accelerated speed. A typical accelerated speed would be 15:1. The present invention can also determine the presence, number of and identity of health care workers in a room or location through voice recognition of through the use of skeletal frame dimensions as determined by IR light scanning techniques.

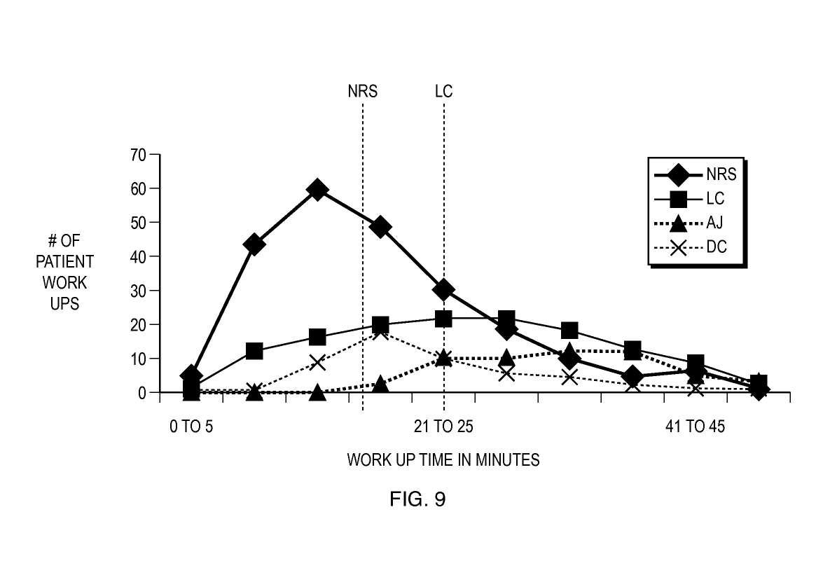

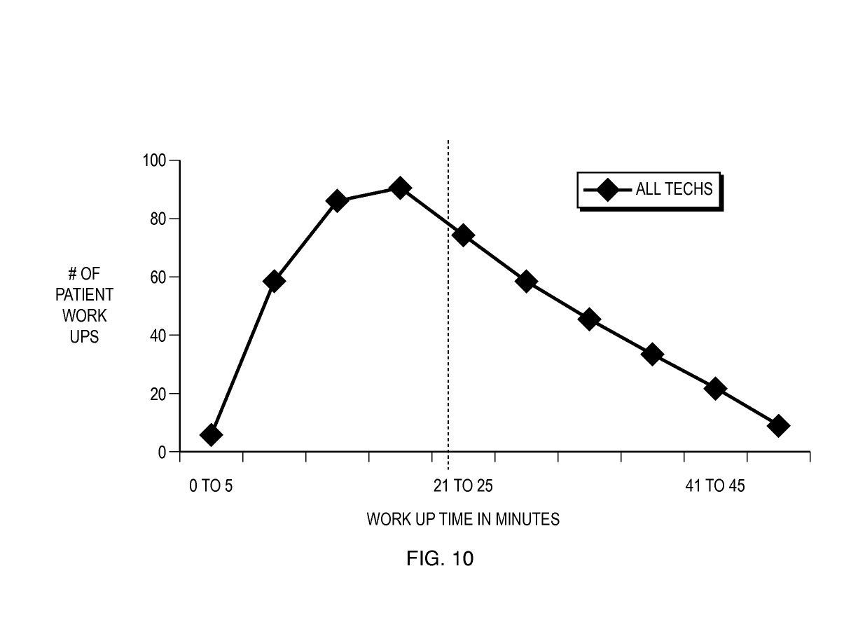

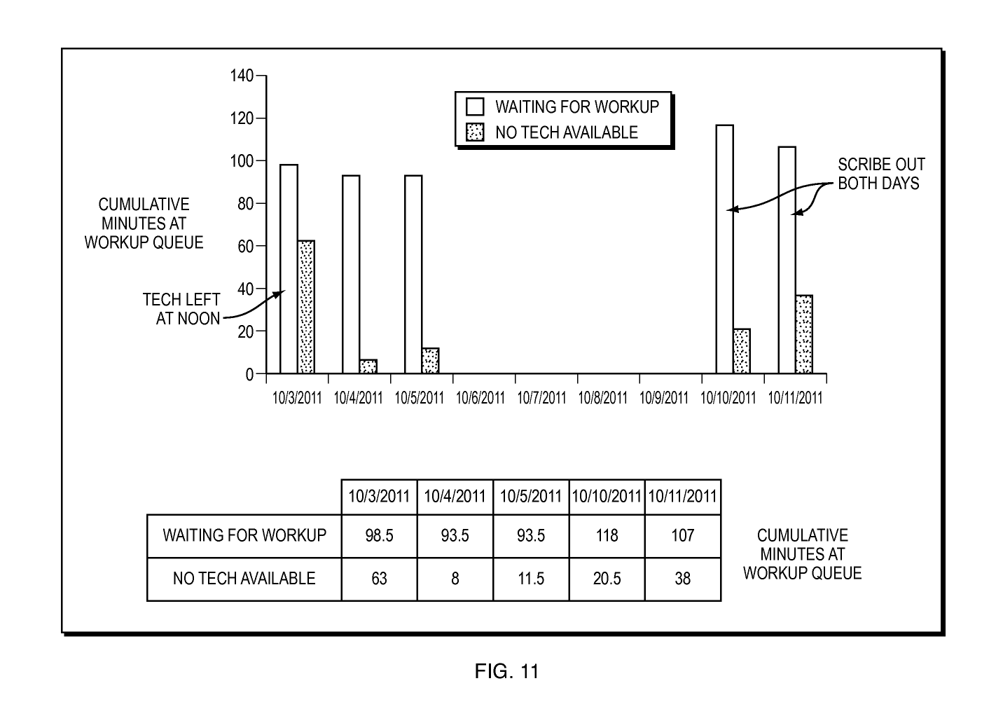

In addition, an almost unlimited number of reports and data analysis displays may be provided as desired and selected by the system administrator/user as shown, for exemplary purposes only, in FIGS. 9 through 11.

In another embodiment, the present invention as described above is configured to provide an Intelligent routing and automated workflow queueing system in order to maximize patient volume, resource efficiency and patient satisfaction with shorter wait times. The system is described as a “care-giver push and automated logic pull queuing system”.

In this embodiment, healthcare workers determine patient care needs as a result of medical screening, chief complaint, and doctor orders. The healthcare worker communicates the care pathway and next process step via the user interface of the automated patient data record processing device.

The patient data record processing device and system determines the activity assignments and priority by patient, staff and equipment use to optimize the workflow to meet the objectives of the healthcare organization.

The system has the capability to calculate a quantitative priority variable for each patient and automatically prioritize and queue patients for the next care step based on the organization's determination of the relative importance of any known specific patient attributes and variables such as (for example): urgent medical needs; special accommodation needs, such as language or wheel chair; VIP status (a patient may be assigned a “VIP status” based on any number of factors including but not limited to age, amount of time the patient has been with the organization, employer group, insurance group or any such similar factors); Participation in a research or clinical trial; appointment reason and anticipated amount of doctor work time needed (long or short visit type); Scheduled appointment start time; Cumulative wait time in the office for this visit; and/or other variables as defined in the future.

In this embodiment, the patient data record processing device and system also has the capability to calculate a quantitative priority variable for each doctor or healthcare provider and to automatically prioritize and queue individual patients for the next care step based on the organization's determination of the relative importance of any known specific provider attributes and variables such as (but not limited to): Provider average processing time for patient visits, by visit type; Provider Critical Resource Value (Relative Scarcity and demand); High demand specialist with low capacity would rate higher than another medical discipline that is in low demand and well resourced; Number of patients in their work-in-process queue; Number of empty queue positions in the work-in-process queue; Projected amount of provider “work time” represented by the patients in their work-in-process queue based on the care needs of each individual patient and the work time required to meet those needs. In other words, how long until the doctor will run out of work based on the number of patients in their work-in-process queue, if no additional patients are added; and Other variables as may be defined in the future on a health care provider by health care provider basis.

The patient data record processing device and system has the capability for automated learning in the software logic function that is, the system may make use of accumulated process data for enhanced precision in automated patient queuing decision making. Examples include: Begin with the use of average population process data for care giver work times. As sufficient care giver work times are recorded and accumulated in the process times database, software queuing and routing decisions begin to be made using more precise data sample sets, such as the average times for the specific patient or groupings of patients that best represent the current specific patient. The software automatically searches for the best sample data that is available and statistically valid.

The patient data record processing device and system has the capability to accurately forecast actual in-take start times for patients that have not arrived yet—based on current patients in process and projected care-giver processing times and completion times. Additional capability is provided to then directly contact the patients that have not arrived via text, email, or other messaging to update them and give them the option to arrive earlier, later, or to reschedule in accordance with the actual forecasted clinic on-time performance.

Accordingly, the present invention provides a system and method for gathering information about a process and procedure and for optimizing this process or procedure utilizing a visual display system incorporating elements of both hardware and software to indicate to the process providers not only the status of the process but also the next step in the process, allowing the process provider(s) to immediately know what step is next in the process and whether any delays or variation in the process are occurring or need to occur. In addition, changes in the process may be made utilizing real time and stored information in order to adjust or modify the intended process methodology.

It is important to note that the present invention is not limited to the preferred, exemplary, or primary embodiment(s) described herein. Modifications and the substitutions by one of ordinary skill in the art are considered to be within the scope of the present invention, which is not to be limited except to the allowed claims and their legal equivalents.

1-8. (canceled)

9. An intelligent routing and automated workflow queuing system for controlling and organizing health care provider patient treatment in a health care provider office, said system comprising:
a plurality of health care provider patient treatment assets located in a health care provider office, said health care provider patient treatment assets including one or more medical staff, a plurality of medical examining rooms and a plurality of medical examination devices;
a central processing system, configured for receiving information related to said health care provider patient treatment assets and individual patient data record information consisting of one or more patient information selected from the group of patient information consisting of urgent to medical needs, special accommodation needs, VIP status, participation in a research or clinical trial, appointment reason, anticipated amount of health care provider work time needed for this visit, scheduled appointment start time, cumulative wait time in the health care provider setting for this visit, and other variables, and responsive to information related to said health care provider patient treatment assets and individual patient data record information, for calculating a quantitative priority variable for each patient and for calculating a quantitative priority variable for each Health Care provider, for automatically prioritizing and queuing patients for a next care step based on said information related to said health care provider patient treatment assets and individual patient data record information; and
a display device, electronically coupled to said central processing means, and configured for displaying each said generated listing of patient data record holding devices including one or more individual patient data records placed therein and each said individual patient data record processing device signal, for providing a visual indication of which patient can and should be processed next based on said health care provider patient treatment assets.

10. The system of claim 1 further including:
a plurality of patient data record holding devices, each of said plurality of patient data record holding devices disposed at a predetermined physical location within said health care provider office, each of said plurality of patient data record holding devices including one or more individual patient data record holders, each said one or more individual patient data record holders configured for providing a patient data record holder signal indicating an individual patient data record has been placed in said individual patient data record holder without regards for providing an indication of individual patient identification associated with said individual patient record, each said patient data record holder signal including an indication of time at which each said individual patient data record was placed in a patient data record holding device and which of said plurality of patient data record holding devices said individual patient data record associated with said patient data record holder signal was transmitted from; and
one or more sensors disposed within each of said plurality of medical examination rooms and each of said plurality of medical examination devices, said one or more sensors configured for providing a signal indicating at least whether each of said plurality of medical examination rooms and medical examination devices are in a first use state or in a second not-in-use state; wherein at least one individual patient data record processing device including a data entry device, said data entry device configured for: (a) allowing a health-care worker to enter information concerning special requirements of an individual patient utilizing patient identification indicia included on said individual patient data record; (b) allowing said health-care worker to identify the next process step required by said individual patient; (c) allowing said health-care worker to enter a health-care worker identification code assigned to said individual patient record; and (d) allowing said health-care worker to enter an indication of which of either or both a medical examination room or a medical examination device is to be used for each individual patient, and for providing an individual patient data record processing device signal containing said individual patient identification indicia and said health-care worker entered information.

11. The system of claim 2, wherein said plurality of sensors disposed within each of said plurality of medical examination are configured for providing an indication of when said examination room is in a not in use state; when said examination room is in an occupied state; when said examination room is in a state identified as occupied by a patient ready for examination by a medical practitioner; and when said examination room is in a state identified as patient in said examination room is being tended to by a medical practitioner.

12. The system of claim 2, wherein at least one of said plurality of patient data record holding devices includes one or more individual patient data record holders associated with a programmable timer, and wherein said central processing means records and provides an indication of an amount of time remaining on said programmable timer, and further were in said central processing means does not include said individual patient data record in and organized generated list of individual patient data records until said programmable timer associated with said individual patient data record has expired.

13. The system of claim 2, wherein said intelligent routing and automated workflow queuing system is responsive to at least said plurality of sensors disposed within each of said plurality of medical examination rooms and each of said plurality of medical examination devices, for computing one or more of the percentage of health-care worker utilization time; the percentage of medical examination room utilization time, and a cumulative individual patient wait time.

14. The system of claim 1, wherein said intelligent routing and automated workflow queuing system is responsive to said plurality of patient data record holding devices, said plurality of sensors disposed within each of said plurality of medical examination rooms and each of said plurality of medical examination devices, and said at least one individual patient data record processing device, for computing patient constraint analysis for providing an indication of constraint data indicating problem areas in the health-care office.

15. The system of claim 1, further including at least one health-care worker entry device, for providing an indication to said intelligent routing and automated workflow queuing system of the availability of each health-care worker for assignment within said health-care provider office.

16. The system of claim 7, wherein said intelligent routing and automated workflow queuing system includes a data base containing information including one or more of: one or more skills possessed by one or more health-care workers; accessibility by disabled individuals to one or more medical examination rooms; and one or more factors to be considered in providing the best, easiest and most timely medical care to each individual patient.

17. The system of claim 7, wherein said intelligent routing and automated workflow queuing system provides information concerning any patient visit to workflow constraint caused by a physical facility constraint, a clinical resource constraint or a combination of both a clinical resource and facility constraint.
